(19) United States
(12) Patent Application Publication
(10) Pub. No.: US 2014/0274359 A1
(43) Pub. Date: Sep. 18, 2014

(54) MULTI-PLAYER COLLABORATIVE PLAY OF A GAME

(71) Applicant: BIG FISH GAMES, INC., Seattle, WA (US)

(72) Inventors: Seppo Takashi Helava, Oakland, CA (US); Andrew James Vella, Oakland, CA (US); Carey Jean DiJulio, Seattle, WA (US)

(73) Assignee: BIG FISH GAMES, INC., Seattle, WA (US)

(21) Appl. No.: 13/802,350

(22) Filed: Mar. 13, 2013

(51) Int. Cl. A63F 13/00

(52) U.S. Cl. CPC A63F 13/00
USPC 463/29

(57) ABSTRACT

The systems and/or processes described herein enable multiple users to play a game in a collaborative and/or competitive manner. Users that are playing the game may be provided with game moves that allow the users to take an action with respect to themselves, to take an action with respect to a different user in collaboration with that user, or to take an action with respect to a different user in competition with that user. In addition, one or more criteria associated with the game may be satisfied based at least in part on multiple users collaborating with one another during play of the game. An enhancement associated with the game may be provided to the collaborating users and may be based on the criteria being satisfied.

### BACKGROUND

With the growing popularity of casual gaming, consumers are able to play various types of games utilizing different mediums, including computing devices, tablet devices, mobile telephones, etc. Individuals may play a particular game independently or with other individuals that are also interested in playing that game. For instance, the individuals may play the game against other individuals or in collaboration with those individuals. Typically, when individuals play a game in collaboration with one another, each of the individuals play the game independently for the purpose of achieving a shared goal relating to the game. As a result, a particular individual that is playing the game may not have an influence on other individuals as they are playing the same game.

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example system including one or more users, one or more user devices, one or more networks, and one or more content servers. In this system, multiple users may collaboratively play a game.

FIG. 2 is diagram showing an example system that includes a content server and various modules used to allow multiple users to collaboratively play a game.

FIG. 3 is a flow diagram showing an example process of facilitating a game move performed by a particular player with respect to a game and other users that are playing the game.

FIG. 4 is a flow diagram showing an example process of enhancing and/or unlocking features of a game based on a collaborative effort of multiple users that are playing the game.

FIG. 5 is a diagram showing an example user interface that presents a game to multiple users, where the multiple users may make game moves that influence how the game is played.

### DETAILED DESCRIPTION

This disclosure describes systems and processes for facilitating play of a game in which multiple users may play the game in a collaborative manner. More particularly, the systems and processes described herein may allow multiple users to play a game in a physical setting or in a virtual environment, where the users may play the game in collaboration with one another or the users may compete against one another. In some embodiments, the users may be grouped into teams that compete against one another, but users on the same team may collaborate in order to compete against a different team. In these embodiments, each of the users may have one or more game moves, which may represent actions that the users may take while playing the game. For a particular user, the game moves may be made with respect to themselves, a user on their own team, and/or a user on a different team. As a result, users on the same team may collaboratively and strategically compete against a different team by making game moves that benefit their own team, while also possibly making game moves that reduce the likelihood of a different team winning the game.

In other embodiments, users may play a game individually and collaboratively with other users at the same time. For example, while a particular user is playing a game, the performance and/or progression of that user with respect to the game may be monitored and displayed to the user. Based on the game performance/progression of the user, the user may cause features of the game to be enhanced, updated, and/or unlocked. In some embodiments, the enhanced, updated, and/or unlocked features may be specifically associated with that user. In addition, the user may collaborate with other users while playing the game. For instance, multiple users may collaborate with one another in order to achieve a shared goal associated with the game. In response to that goal being achieved, various features of the game may be enhanced/upgraded and/or unlocked. In various embodiments, the enhanced, upgraded, and/or unlocked features may be available to those users that participated in causing those features to be enhanced/upgraded and/or unlocked. That is, the enhanced/upgraded and/or unlocked features may not be displayed or available to users that that did not collaborate with the participating users. As a result, users that are playing the game may have an incentive to collaborate with other users in order to access additional game content.

The discussion begins with a section, entitled “Example Environment,” describing a system for facilitating play of a collaborative and/or competitive game by multiple users. Next, the discussion includes a section, entitled “Example Content Server(s),” that illustrates and describes an example content server that includes multiple modules that facilitate collaborative and/or competitive play of a game. An “Example Processes” section then follows, which describes example processes for enabling users to play a game in a collaborative manner in an attempt to achieve a shared goal associated with the game. The discussion then moves on to an “Example User Interface” section that illustrates users 102 playing a game in a collaborative and/or competitive manner. Lastly, the discussion includes a brief “Conclusion.”

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Example Environment

FIG. 1 illustrates an architecture 100 in which a user 102 may electronically or physically access games 116 (e.g., software games, casual games, physical games, games played for real or virtual currency, games of chance, etc.) and play those games 116, such as via a user device 104. As described below, the user device 104 may be implemented in any number of ways, such as a computer, a laptop computer, a tablet device, a personal digital assistant (PDA), a multi-functioning communication device, and so on. The user 102 may access the games 116 over a network 106, such as the Internet, which may be communicatively coupled to one or more content server(s) 108. The content server(s) 108 may store various types of games 116, such as software games, and other content that is accessible by the user device 104 (e.g., media content, audio content, video content, etc.). For instance, the user 102 may access and/or play the games 116 via one or more sites (e.g., a website) that are accessible via the network(s) 106 and/or via an application associated with the user device 104. One or more processor(s) 110, a memory 112, and a display 114 of the user device 104 may enable the user 102 to access and/or play the games 116. In addition to the games 116 being stored on, and/or accessed via, the content server(s) 108, the games 116 may also be stored directly on the user device 104.

Furthermore, one or more processor(s) 118 and a memory 120 of the content server(s) 108 may allow the content server(s) 108 to enable the users 102 to play the games 116 in a collaborative and/or competitive manner. More particularly, a game play module 122, a game management module 124, and a game enhancement module 126 are stored in memory 120 and executed by the processor(s) 118 to facilitate play of a collaborative and competitive game 116 being played by multiple users 102. In addition, the foregoing modules may further be executable by the one or more processor(s) 118 to enable multiple users 102 to collaboratively play a game 116 for the purpose of enhancing, upgrading, and/or unlocking one or more features of the game 116, where the enhanced, upgraded, and/or unlocked features are available only to those users 102 that participated in making those features available.

For the purposes of this discussion, the games 116 may include physical games 116 and games 116 that may be played online or via a user device 104. Moreover, the games 116 may be played for real currency (e.g., U.S. dollars) or virtual currency (e.g., chips, tokens, etc.). The games 116 may also relate to games of chance or casual gaming, which may include physical games, online games that may be played over the network(s) 106, and/or software games that may be stored on, and/or be accessible by, the user device 104.

Games of chance may refer to games in which the outcome is at least partly random or is influenced at least in part by a randomizing device. In games of chance, the players may elect to wager real or virtual currency, or anything of monetary value, prior to at least a portion of the game being played (e.g., spinning a set of reels). Examples of games of chance may include physical games, games played via a network 106, or games played via a user device 104, such as dice games, spinning tops, playing cards, slot machines, roulette wheels, and many other casino games. A game of chance may have some skill element, although the chance or randomness of the game may play a greater role in determining the outcome of the game. In other games of chance, a certain degree of skill may enhance a player's performance with respect to the game. This may be the case where the player(s) make game decisions based upon previous or incomplete knowledge, such as in various casino or card games (e.g., blackjack, poker, etc.).

Casual games may include games (e.g., video games) that are associated with any type of gameplay and any type of genre. Casual games may have a set of simple rules that allow a large audience to play, such games that may be played utilizing a touch-sensitive display, a telephone keypad, a mouse having one or two buttons, etc. Moreover, casual games may not require a long-term commitment or unique skills to play the game, thus allowing users 102 to play the game in short time increments, to quickly reach a final stage of the game, and/or to continuously play the game without needing to save the game. Casual games may also be played on any medium, including personal computers, game consoles, mobile devices, etc., and may be played online via a web browser. Casual games may be referred to as “casual” since the games may be directed towards consumers who can come across the game and get into gameplay in a short amount of time, if not immediately. Examples of casual games may include puzzle games, hidden object games, adventure games, strategy games, arcade and action games, word and trivia games, casino games, and/or card and board games.

Other games 116 may first be downloaded to and/or installed on the user device 104 and/or an application associated with the user device 104. These games 116, and the physical games, the games of chance (including physical and virtual games), and the casual games 116 described above, may also be acquired by the user 102. Regardless of whether the games 116 are stored on the user device 104 or the content server(s) 108, playing the games 116 may include accessing, viewing, trying, and/or otherwise interacting with the games 116.

The users 102 may access the games 116 in any of a number of different manners. For instance, the users 102 may play the games 116 in a physical setting (e.g., physical slot machines, card games, etc.). The users 102 may also access a site (e.g., a website) associated with an entity, such as a merchant, that provides access to the games 116. Such a site may be remote from the user device 104 but may allow the users 102 to interact with the games 116 via the network(s) 106. Moreover, the users 102 may download one or more applications to the user device 104 in order to access the games 116. In this case, the content server(s) 108 may provide, transmit, suggest, and/or recommend the games 116 to the user device 104, whereby the users 102 may interact with the games 116 via the downloaded application(s). In other embodiments, the games 116 may be streamed from the content server(s) 108 to the user device 104 such that the users 102 may interact with the games 116 in real-time. Once the user 102 accesses the games 116, the users 102 may perform a variety of actions, including learning about the games 116, viewing the games 116, trying the games 116, acquiring (e.g., purchasing, renting, leasing, etc.) the games 116, downloading/installing the games 116 to the user device 104, and/or playing the games 116.

Additionally, the users 102 may have a user account associated with the entity that provides and/or provides access to the games 116. For instance, assuming that the games 116 are available via a website, each of the users 102 may have a user account that specifies various types of information relating to the users 102. This information may include personal information, user preferences, and/or some user identifier (ID), which may be some combination of characters (e.g., name, number, etc.) that uniquely identifies the user 102 from other users 102.

In some embodiments, the user device 104 may be any type of device that is capable of receiving, accessing, playing, and/or otherwise interacting with the games 116, such as, for example, a personal computer, a laptop computer, a cellular telephone, a personal digital assistant (PDA), a tablet device, an electronic book (e-Book) reader device, a television, or any other device that may be used to access games 116 that may be viewed, tried, played, downloaded, installed, and/or acquired by the user 102. For instance, the user 102 may utilize the user device 104 to access and navigate between one or more sites, such as web sites, web pages related thereto, and/or documents or content associated with those websites or web pages that may be of interest to the user 102. For instance, the user 102 may utilize the user device 104 to access sites to view, play, and/or download the games 116. Further, the user device 104 shown in FIG. 1 is only one example of a user device 104 and is not intended to suggest any limitation as to the scope of use or functionality of any user device 104 utilized to perform the processes and/or procedures described herein. Although the games 116 may be played via the user device 104, certain games 116 may be played without the use of a user device 104. For example, various physical games and/or games of chance (e.g., slot machines, table top games, etc.) may be played in a physical setting without use of such user devices 104.

The processor(s) 110 of the user device 104 may execute one or more modules and/or processes to cause the user device 104 to perform a variety of functions, as set forth above and explained in further detail in the following disclosure. In some embodiments, the processor(s) 110 may include a central processing unit (CPU), a graphics processing unit (GPU), both CPU and GPU, or other processing units or components known in the art. For instance, the processor(s) 110 may allow the user device 104 to access sites associated with games 116 and/or download applications that are used to access and/or play the games 116. Additionally, each of the processor(s) 110 may possess its own local memory, which also may store program modules, program data, and/or one or more operating systems.

In at least one configuration, the memory 112 of the user device 104 may include any component that may be used to access, play, and/or download the games 116. Depending on the exact configuration and type of the user device 104, the memory 112 may also include volatile memory (such as RAM), non-volatile memory (such as ROM, flash memory, miniature hard drive, memory card, or the like) or some combination thereof.

In various embodiments, the user device 104 may also have input device(s) such as a keyboard, a mouse, a pen, a voice input device, a touch input device, etc. The user device 104 may also include the display 114 and other output device(s), such as speakers, a printer, etc. The user 102 may utilize the foregoing features to interact with the user device 104 and/or the content server(s) 108 via the network(s) 106. More particularly, the display 114 of the user device 104 may include any type of display known in the art that is configured to present (e.g., display) information to the user 102. For instance, the display 114 may be a screen or user interface that allows the user 102 to access, play, and/or download the games 116. Further, one or more local program modules may be utilized to play the games 116 on a browser. The local program modules may be stored in the memory 112 and/or executed on the processor(s) 110 in order to present graphics associated with the games 116 on the display 114.

In some embodiments, the network(s) 106 may be any type of network known in the art, such as the Internet. Moreover, the user device 104 and the content server(s) 108 may communicatively couple to the network(s) 106 in any manner, such as by a wired or wireless connection. The network(s) 106 may also facilitate communication between the user device 104 and the content server(s) 108, and also may allow for the transfer of data or communications therebetween. For instance, the content server(s) 108 and/or other entities may provide access to the games 116 that may be accessed, played, and/or downloaded utilizing the user device 104.

In addition, and as mentioned previously, the content server(s) 108 may include one or more processor(s) 118 and a memory 120, which may include the game play module 122, the game management module 124, and the game enhancement module 126. The content server(s) 108 may also include additional components not listed above that perform any function associated with the content server(s) 108. In various embodiments, the content server(s) 108 may be any type of server, such as a network-accessible server, or the content server(s) 108 may be any entity that provides access to the games 116 that is stored on and/or is accessible by the content server(s) 108.

In various embodiments, the game play module 122 may enable a single user 102 or multiple users 102 to play one or more of the games 116. In particular, the game play module 122 may allow multiple users 102 to play one of the games 116 in a physical setting or a virtual environment. In some embodiments, multiple different users 102 may independently play a single player game 116 in the virtual environment, where each of the users 102 is represented within the virtual environment by text, an image, an avatar, and/or other identifying information. During play of the game 116, each user 102 may play in collaboration with other users 102, may play with a team of users 102, or may compete against other users 102, either as an individual or as a team. The performance and/or progression of the users 102 may be monitored and displayed to the users 102, where the performance/progression associated with the game 116 may be represented by an amount of points, an amount of currency (e.g., awards, trophies, dollars, chips, prizes, etc.), reaching or passing levels associated with the game 116, etc.

Furthermore, the game management module 124 may facilitate the play of game moves 128 made by the users 102 while those users 102 are playing the game 116. The game moves 128 may correspond to any action or operation taken by users 102 with respect to the game 116. For instance, the game moves 128 may include drawing a card, striking an opponent, spinning a set of reels, etc., for the purpose of achieving a particular goal associated with the game 116. The users 102 may make the game moves 128 with respect to their own play of the game 116, or the game moves 128 may relate to other users 102 that are also playing the game 116, such as different users 102 that are playing the game 116 in collaboration with the user 102 and/or users 102 that are playing the game 116 in competition with the user 102. As a result, the game management module 124 may allow user 102 to have an influence on the play of other users 102 that are also playing the game 116.

The game enhancement module 126 may allow for one or more game features 130 (also referred to herein as “features”) to be enhanced, upgraded, and/or unlocked. More particularly, the game features 130 may be enhanced, upgraded, and/or unlocked in response to one or more criteria or thresholds being satisfied. In various embodiments, multiple users 102 may collaborate with one another in order to achieve a shared goal (e.g., an amount of points, an amount of currency, the passing of levels associated with the game 116, etc.), which may be represented by the criteria/thresholds. When it is determined that the shared goal has been reached, the game enhancement module 126 may enhance, upgrade, and/or unlock one or more of the game features 130 with respect to the users 102 that participated in causing the game features 130 to become enhanced, upgraded, and/or unlocked. That is, the enhanced, upgraded, and/or unlocked game features 130 may be associated with those participating users 102 such that game features 130 may only be displayed to, available to, and/or accessible by those participating users 102. On the other hand, users 102 that did not participate in this collaboration may not have access to the enhanced, upgraded, and/or unlocked game features 130.

In certain embodiments, the criteria may correspond to events associated with the game 116 that may occur or that may be caused by actions of at least one of the multiple users 102 that is currently playing the game 116. For instance, the predetermined criteria may correspond to one of the users 102 achieving a certain score, gaining a particular amount of currency (e.g., points, dollars, trophies, chips, awards, etc.), receiving one or more particular cards, and/or hitting a particular set of reels in a virtual slot machine game 116 context. By monitoring the status, performance, progression, etc., of each user 102 that is playing the game 116, the game management module 124 may determine when one of the criteria/thresholds has been satisfied, meaning that the game management module 124 may determine when one of the events that is associated with the game 116 has occurred.

### Example Content Server(s)

FIG. 2 illustrates an example content server 108 that enables multiple users to play a game in a collaborative and/or competitive manner. More particularly, the content server(s) 108 as illustrated in FIG. 2 may include the one or more processor(s) 118 and the memory 120, which may maintain or be associated with the games 116, the game play module 122, the game management module 124, and the game enhancement module 126. In various embodiments, the game management module 124 may include a game moves module 202, a user collaboration module 204, and a competition module 206. Furthermore, the game enhancement module 126 may include a single player module 208, a multi-player module 210, a feature enhancement module 212, and a feature unlocking module 214.

As stated above, the game play module 122 may enable one or multiple users 102 to play a particular game 116, such as enabling users 102 to play the game 116 within a virtual environment. Moreover, the game management module 124 may facilitate the collaborative and/or competitive play of the game 116 by multiple users 102. More particularly, the game management module 124 may enable the multiple users 102 to make game moves 128 with respect to the game 116.

In certain embodiments, the game moves module 202 may enable the users 102 that are playing the game 116 to make or perform one or more game moves 128. For the purposes of this discussion, the a game move 202 may correspond to any move, action, operation, play, etc., that a user 102 may make with respect to the game 116. Regarding a particular user 102 that makes a game move 128, the game move 128 may be played with respect to that user 102, one or more users 102 that are playing in collaboration with the user 102 (e.g., users 102 that are on the same team as the user 102), and/or users 102 that are playing against or in competition with the user 102 (e.g., users 102 on a different team). As a result, the game moves module 202 may allow the users 102 to influence play of the game 102 with respect to themselves and with respect to other users 102 that are also playing the game 116.

Therefore, users 102 may use the game moves 128 individually to help themselves, collaboratively to help some users 102 (e.g., users 102 on the same team), and competitively to work against other users 102, such as users 102 on a different team or users 102 that a particular user 102 is playing against. In various embodiments, the game moves module 202 may allow each user 102 to have a certain amount of game moves 128, and may also allow the users 102 to use the game moves 128 and to earn additional game moves 128. Moreover, the game moves 128 that a particular user 102 possesses may be the same as those of other users 102, different from those of other users 102, or a combination of the two, meaning that multiple users 102 may have game moves 128 in common with other users 102 and game moves 128 that are different from other users 102.

In various embodiments, in order to earn additional game moves 128, a user 102 may need to satisfy various criteria, such as earning a cumulative amount of points/currency associated with the game 116, passing a level of the game 116, playing a certain number or combination of game moves 128, and so forth. Moreover, the play of particular game moves 128 or the performance of a particular user 102 with respect to the game 116 may cause additional or new game moves 128 to be available or provided to users 102. In addition, each of the game moves 128 may influence the game 116 differently and certain game moves 128 may have different effects (e.g., more effective, less effective, etc.) than other game moves 128. Specific examples of the game moves 128 may be illustrated and described with respect to FIG. 5.

The user collaboration module 204 may allow a user 102 to play the game moves 128 for their own benefit, or may allow the use 102 to play the game moves 128 collaboratively or cooperatively with other users 102, such as users 102 that are on the same team as the user 102 or other users 102 that are not competing with the user 102. For instance, the user collaboration module 204 may allow the user 102 to make a game move 128 for the purpose of changing, benefitting, or otherwise influencing their own play of the game 116.

In addition, the user 102 may make a game move 128 for the purpose of changing, benefitting, or otherwise influencing the play of other users 102 with respect to the game 116. For example, the user 102 may make a game move 128 on behalf of a different user 102 (e.g., a team member), make a game move 128 that influences play of the game 116 for a different user 102, or may give, sell, donate, etc., a game move 128 to a different user 102. Therefore, players of the game 116 that share a common goal may play the game moves 128 strategically in order to increase the likelihood of those users 102 (or the team) winning the game 116, or at least winning a component (e.g., a level, a stage, etc.) of the game 116. In addition, users 102 that have a common goal or strategy with respect to the game 116 may play their game moves 128 together in order to benefit each of those users 102. For instance, users 102 on the same team may make game moves 128 at the same time, around the same time, consecutively, alternatively, etc., for the purpose of increasing their performance with respect to the game 116 or increasing the likelihood that their team will win the game 116. As a result, the user collaboration module 204 may facilitate a real-time, multi-player collaborative or cooperative element to the game 116.

In other embodiments, the competition module 206 may allow the users 102 to play game moves 128 in a competitive manner. More particularly, users 102 that are playing the game 116 may play the game moves 128 for the purpose of hindering, negatively affecting, or influencing other users 102 that are playing the game 116. Such users 102 may be players on a competing team or players that are individually competing against the user 102. In some embodiments, a user 102 may play or make a game move 128 that may increase the likelihood that that user 102 will win the game 116 (e.g., or beat the competitor) and/or may decrease the likelihood that another users 102 will win the game 116. As a result, although the game move 128 may not directly influence that user's 102 play of the game 116, by playing the game move 128 with respect to a different user 102, the user 102 may nonetheless indirectly influence the game 116 with respect to that user 102.

As discussed above, the game enhancement module may facilitate a multi-user collaborative game 116 in which users 102 may enhance, upgrade, and/or unlock features 130 associated with the game 116. In various embodiments, the single player module 208 may enable a single user 102 to independently play the game 116. More particularly, based at least in part on the performance or progression of the user 102 with respect to the game 116 (e.g., earning a cumulative amount of points/currency, passing a level, playing the game 116 a predetermined amount of time, etc.), the user 102 may cause certain features 130 of the game 116 to be enhanced, upgraded, and/or unlocked. That is, existing features 130 that were available to the user 102 may be enhanced or upgraded, or features 130 that were previously not available to the user 102 may become available, or may be presented to the user 102. In some embodiments, the enhanced, upgraded, and/or unlocked features 130 may be specifically associated with the user 102 such that those features would not be available or presented to other users 102.

The multi-player module 210 allows multiple different players of the game 116 to play the game 116 in collaboration or cooperation with one another, possibly to achieve a common goal with respect to the game 116. In particular, the multi-player module 210 may enable multiple users 102 to play the game 116 in collaboration with one another for the purpose of enhancing, upgrading, and/or unlocking one or more features 130 of the game 116. Upon satisfying a criteria or threshold associated with the game 116, such as by earning a cumulative amount of points/currency, multiple users 102 may cause the game feature 130 to be enhanced, upgraded, and/or unlocked. In some embodiments, the enhanced, upgraded, and/or unlocked features 130 may be available only to those users 102 that participated in causing those features 130 to be enhanced, upgraded, and/or unlocked, while those game features 130 may not be available or presented to other users 102.

In certain embodiments, as additional users 102 collaborate in an attempt to enhance, upgrade, and/or unlock such features 130, those features 130 may be enhanced, upgraded, and/or unlocked more quickly or more frequently. Moreover, those features 130 may only be available to those users 102 that participate. As a result, users 102 may have an incentive to collaborate with other users 102, thus forming a community of users 102, and to spend resources (e.g., points, currency, etc.) during play of the game 116.

The feature enhancement module 212 may cause one or more features 130 of the game 116 to become enhanced and/or upgraded, possibly in response to one or more criteria associated with the game 116 being satisfied. The enhancement or upgrade may correspond to game features 130 that were previously available to the users 102. Instead of automatically enhancing and/or upgrading the game features 130, the feature enhancement module 212 may give users 102 the opportunity to enhance/upgrade those features 130, such as by providing the users 102 the opportunity to provide consideration (e.g., points, currency, etc.) in exchange for upgrading/enhancing those features 130. Moreover, the features 130 may be enhanced/upgraded in their visual appearance (e.g., color, brightness, resolution, detail, etc.), their functionality, or in any other manner that increases the enjoyability or experience of playing the game 116. In some embodiments, the feature enhancement module 212 may also provide an additional number of features 130 that were already available to users 102. Moreover, the enhanced/upgraded features 130 may allow the users 102 to play the game 116 more effectively or at a higher performance level, or may increase the likelihood that the users 102 may win the game 116.

The feature unlocking module 214 may cause one or more features 130 of the game 116 that were previously unavailable to users 102 to be unlocked and, therefore made available, to those users 102. The unlocked features 130 may allow the users 102 to play the game 116 more effectively, may allow the users 102 to play the game 116 at a higher performance level, and/or may cause the users 102 to have a higher likelihood of winning the game 116 or competing against opponents who are also playing the game 116. As stated above, the features 130 may be unlocked in response to a community of users 102 collaborating with one another for the purpose of satisfying certain predetermined criteria (e.g., achieving a goal associated with the game 116). When it is determined that the criteria has been satisfied, the features 130 may be unlocked for those users 102 that participated in causing the features 130 to become unlocked. On the other hand, the unlocked features 130 may not be available to those users 102 that did help cause those features 130 to be unlocked.

In some embodiments, the criteria may occur or be satisfied while the users 102 are playing the game 116. Such criteria may relate to one of the users 102 achieving a certain score, obtaining a particular amount of points or currency, receiving a specific card or set of cards, hitting a particular set of reels, passing a level of the game 116, collaborating with a certain number of other users 102, and so on. Therefore, the criteria may correspond to events associated with the game 116 that may occur during game play, in which the events may occur in response to one or multiple users 102 performing a particular action (e.g., pressing a button, playing a card, beating an opponent, reaching a goal, spinning reels, spending points or currency, etc.) with respect to the game 116. By monitoring each of the multiple users 102 as they are playing the game 116, the content server(s) 108 may determine when one of the criteria has been satisfied.

Alternatively, or in addition to automatically unlocking features 130 of the game 116, the feature unlocking module 214 may provide an opportunity for users 102 to unlock or receive access to those game features 130, which may include providing the opportunity only to those users 102 that participated in satisfying the predetermined criteria associated with the game 116 (while other users 102 would not have such an opportunity). For instance, the feature unlocking module 214 may provide users 102 the opportunity to acquire the features 130 that are eligible to be unlocked, such as by spending virtual points or currency associated with the game 116.

In some embodiments, provided that the game 116 involves allowing users 102 to earn and spend real or virtual currency (e.g., dollars, points, coins, tokens, etc.), the feature unlocking module 214 may offer a sale of, or a discount on, features 130 (e.g., game items) associated with the game 116. In other embodiments, the sale may specifically relate to the currency itself, such that users 102 may acquire additional currency at a discounted price. Such a sale may be triggered or become available in response to a community of users 102 collaboratively performing a specified action or goal associated with the game 116. For instance, the feature unlocking module 214 may cause features 130 to be unlocked, allow users 102 an opportunity to cause those features 130 to become unlocked, and/or offer a sale or discount for the features 130 or the currency that may be used to acquire those features 130.

As a result, users 102 that are playing the game 116 may engage in a community effort to accomplish tasks or goals in order to unlock game features 130, receive an opportunity to receive access to those features 130, and/or to be provided a sale or discount on the features 130 or currency associated with the game 116. In various embodiments, to achieve the foregoing, a certain number of users 102 may have to participate in the collaborative effort. Moreover, the users 102 may have to identify and find a certain number of users 102 that are willing and able to play the game 116 in a collaborative manner in order to satisfy the criteria. Accordingly, users 102 may be encouraged to spend their own currency to further play the game 116, which may result in a better and more enjoyable gaming experience, and which may result in additional proceeds for the entity that provides the game 116.

### Example Processes

FIGS. 3 and 4 describe various example processes of enabling collaboration between multiple users with respect to playing a game. The example processes are described in the context of the environment of FIGS. 1 and 2 but are not limited to those environments. The order in which the operations are described in each example method is not intended to be construed as a limitation, and any number of the described blocks can be combined in any order and/or in parallel to implement each method. Moreover, the blocks in FIGS. 3 and 4 may be operations that can be implemented in hardware, software, or a combination thereof. In the context of software, the blocks represent computer-executable instructions stored in one or more computer-readable storage media that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 3 is a flow diagram illustrating an example process 300 of enabling users to independently, collaboratively, and/or competitively play game moves with respect to a game. Moreover, the following actions described with respect to FIG. 3 may be performed by a server, a service provider, a merchant, and/or the content server(s) 108, as shown in FIGS. 1 and 2.

Block 302 illustrates facilitating play of a game by multiple users. In some embodiments, the content server(s) 108 may determine that multiple users 102 are independently playing a game 116 (e.g., a single player game 116 or a multi-player game 116), which may be associated with a physical or a virtual environment. For the purposes of this discussion, a single player game 116 may refer to a game 116 that may be played independently of other users 102, meaning that the performance or progression of a first user 102 with respect to the game 116 may not have an affect or influence on another user's 102 play of the game 116. Moreover, a multi-player game 116 may correspond to a game 116 where multiple users 102 may play the game 116 in collaboration or competition with other users 102 that are also playing the game 116.

The environment may present information about each of the users 102 that is viewable by the other users 102 that are currently participating in (e.g., playing) the game 116. In some embodiments, such information may include text, graphics, images, avatars, etc., that identify the users 102. In addition, the information may include a current status or performance of each user 102 with respect to the game 116, such as a current score, an amount of currency earned, cards received, reels hit, jackpots won, etc. As a result, each of the users 102 that is playing the game 116 within the environment may determine which other users 102 are also playing the game 116, and may be aware of the current status or performance of those users 102.

In some embodiments, although the multiple users 102 may each be independently playing a single player game 116, the game 116 may still have a social component. For instance, the users 102 playing within the environment may communicate with the other users 102, such as by exchanging messages in the form of an online chat. The name, image, avatar, etc., associated with the users 102 may allow the users 102 to determine players that they know, have previously played with, etc. Moreover, since the users 102 that are playing the game 116 may be placed within a virtual environment with other users 102 who are also online, each user 102 may view the performance, progression, and current status of other users 102 with respect to the game 116 (e.g., a cumulative amount of points/currency, game level reached, number of games 116 played, game moves 128 played, etc.).

Block 304 illustrates providing and managing game moves that are associated with the multiple users. More particularly, each of the users 102 may have or be associated with one or more game moves 128 that the users 102 may play with respect to the game 116. As discussed above with respect to FIG. 2, the game moves 128 may correspond to any move, act, or play that a user 102 may take while playing the game 116. For instance, users 102 may play game moves 128 for their own benefit, game moves 128 that benefit of other users 102 that are playing the game 102 (e.g., users 102 on the same team), and/or game moves 128 that have a negative effect on other users 102 (e.g., users 102 on a different team or users 102 that the user 102 is playing against). As a result, the game moves 128 may be played in a collaborative and/or competitive manner.

Block 306 illustrates determining that at least one of the users has played a game move. In some embodiments, the content server(s) 108 may monitor play of the game 116 in order to determine whether any game moves 128 have been played. For instance, the content server(s) 108 may determine that a particular user 102 has made a specific game move 128 with respect to themselves and/or another user 102 that is playing the game 116.

Block 308 illustrates performing an action with respect to the game based at least in part on the game move. In particular, in response to determining that a game move 128 has been played by one of the users 102, the content server(s) 108 may perform an action or operation that corresponds to that game move 128. For example, if the game move 128 that corresponds to adding a card to the hand of a completing user 102 is played, the content server(s) 108 may cause a card to be added to that user's 102 hand of cards. As a result, the content server(s) 108 may cause various individual, collaborative, and/or competitive game moves 128 to be performed with respect to the game 116.

FIG. 4 is a flow diagram 400 illustrating an example process of enabling a community of users to collaboratively enhance, upgrade, and/or enhance one or more features associated with a game. Moreover, the following actions described with respect to FIG. 4 may be performed by a server, a service provider, a merchant, and/or the content server(s) 108, as shown in FIGS. 1 and 2.

Block 402 illustrates facilitating play of a game by multiple users. As discussed above with respect to FIG. 3, the content server(s) 108 may allow one or more users 102 to play a game 116 in a physical or a virtual environment. The users 102 may play the game 116 independently and/or in collaboration with other users 102 that are also playing the game 116. In various embodiments, the content server(s) 108 may monitor the performance and/or progression of the users 102 with respect to the game 116.

Block 404 illustrates determining that a criteria associated with the game has been satisfied. In certain embodiments, the criteria may correspond to a particular action, operation, goal, accomplishment, etc., associated by the game 116 that may be caused by or achieved by the users 102. For instance, the criteria may correspond to a cumulative amount of points or currency to be earned, a time duration in which the users 102 have played the game 116, a progression through the game 116, etc. A particular user 102 may attempt to satisfy this criteria independently while playing the game 116, or multiple users 102 may collaborate with one another in order to cause the criteria to be satisfied. For example, the criteria may represent a goal that may be achieved by a community of users 102 that are playing the game 116.

Block 406 illustrates determining one or more of the multiple users that contributed to satisfying the criteria. In particular, provided that multiple users 102 collaborated with one another in order to satisfy the criteria, the content server(s) 108 may identify which users 102 actually participated in this collaboration. For example, assume that the criteria corresponds to users 102 earning a predetermined amount of points or currency associated with the game 116, and that the content server(s) 108 allows multiple users 102 to contribute towards reaching this points/currency total. In these embodiments, the content server(s) 108 may determine which users 102 actually earned points/currency while playing the game 116 for the purpose of reaching this predetermined amount of points/currency.

Block 408 illustrates enhancing and/or unlocking one or more features of the game based on the criteria being satisfied. In response to determining that the criteria has been satisfied, the content server(s) 108 may cause one or more features 130 associated with the game 116 to be enhanced and/or upgraded, as discussed above with respect to FIG. 2. In addition, the content server(s) 108 may cause one or more features 130 to be unlocked, meaning that features 130 that were previously unavailable may become available or presented to users 102.

Block 410 illustrates causing the enhanced and/or upgraded features to be available to the one or more users. More particularly, the enhanced, upgraded, and/or unlocked features 130 of the game 116 may be dynamically made available when the criteria is satisfied. In some embodiments, the enhanced, upgraded, and/or unlocked features 130 may be made available only to those users 102 that participated in causing those features 130 to become enhanced, upgraded, and/or unlocked. That is, the community of users 102 that collaborated with one another in order to satisfy the criteria may have access to the enhanced, upgraded, and/or unlocked features 130, while the users 102 that did not participate may not have such access. As a result, users 102 may be incentivized to, and may receive benefits from, collaborating with other users 102 during play of the game 116.

### Example User Interface

FIG. 5 illustrates an example user interface that illustrates multiple users playing a game in an environment 500, which may include a physical environment or a virtual environment. More particularly, multiple users 102(1)-102(4) (collectively referred to as “users 102”) may each be situated around, or in close proximity to, a table 502 (e.g., a real table, a virtual table, etc.) within the environment 500, where each of the users 102 may be playing a game 504. As illustrated in FIG. 5, although any game 504 may be played, the game 504 being played by each of the users 102 may be a card game 504 with each of the users 102 having a particular hand of cards. The game 504 may be any card game 504 where the users 102 may play their cards with respect to one another (e.g., poker, euchre, etc.).

As shown, each of the users 102 may have their own set of cards. In various embodiments, the users 102 may be playing the card game 504 independently from the other users 102, thus making the card games 504 single player games 504. In response to the users 102 betting currency (e.g., points, coins, chips, etc.) and playing the game 504 (e.g., receiving or playing the cards), the users 102 may win points and/or currency based on the cards that are received or played.

Since each of the multiple users 102 may be situated around a table 502 within the environment 500, the game 504 may have a social or interactive component. For instance, the users 102 may communicate (e.g., chat, send messages, etc.) with one another while the users 102 are playing the game 504. Moreover, the users 102 may determine various information about the other users 102 that are playing the game 504 within the environment 500. For instance, the environment 500 may display whether any of the users 102 are on the same team or are on competing teams. Therefore, the users 102 may play the game 504 in collaboration with some users 102 and in competition with other users 102. As shown in FIG. 5, there are four users 102 situated around the table 502. Moreover, FIG. 5 illustrates that user 102(1) and user 102(3) are on “Team 1” whereas user 102(2) and user 102(4) are on “Team 2.” Therefore, the users 102 may be divided into two teams that are competing against each other.

The environment 500 may also display user information 506 for each of the users 102. In some embodiments, the user information 506 may correspond to any information that identifies the users 102. Such information may include text (e.g., a name, username, etc.), symbols, images, or an avatar that represents the users 102 or that is otherwise selected by the users 102. This identifying user information 506 may allow a particular user 102 to determine who else is playing the game 504, which may include users 102 that the user 102 is familiar with or has previously played with. In other embodiments, the user information 506 may indicate contacts or friends of the user 102, demographic information about the user 102, etc. The content server(s) 108 may utilize this user information 506 to identify users 102 that share similar characteristics (e.g., gender, age, preferred games 504, game performance, experience level, etc.), and thus may want to play the game 504 with each other. The content server(s) 108 may also identify games 504 that users 102 may be of interest to users 102 and then recommend those games 504.

In additional embodiments, the environment 500 may display game data 508 for each of the users 102. The game data 508 may represent the game 504 each user 102 is playing, a current status or performance of that user 102 with respect to the game 504, such as the user's 102 progression through the game 504, an experience level of the user 102, the user's 102 previous performance with respect to that game 504 or other games 504, etc. For instance, the game data 508 may indicate a duration the user 102 has played the game 504 and/or an extent to which the user 102 has progressed through the game 504. Moreover, the game data 508 may represent a currency (e.g., points, chips, coins, etc.) associated with the user 102, such as an amount of currency won for a particular hand of the card game 504, an amount bet by the user 102, and/or a cumulative amount of currency earned or won by the user 102.

During play of the game 504, each of the users 102 may make or play one or more game moves 128, which may correspond to the users 102 playing a particular card, drawing a card, or taking some other action with respect to the game 504. More particularly, one of the users 102 (e.g., user 102(1)) may make different types of game moves 128, such as an individual game move 510, a collaborative game move 512, and/or a competitive game move 514. An individual game move 510 may correspond to a user 102 taking some action relating to the game 504 for the benefit of himself/herself. For instance, an individual game move 510 may include playing a card, receiving a card, drawing a card, etc., in which each may be game moves 128 that are independent of the other users 102 that are playing the game 504.

Moreover, a collaborative game move 512 may correspond to a game move 128 that is made in collaboration with another user 102. For instance, a collaborative game move 512 may be made for the purpose of benefitting another user 102 that is playing the game 504. As shown in FIG. 5, user 102(1) may make a collaborative game move 512 with respect to user 102(3), who is shown as being on the same team as user 102(1). Therefore, user 102(1) may make the collaborative game move 512 to assist, help, or benefit user 102(3) in playing the game 504. For instance, the collaborative game move 512 may include user 102(1) giving a card to user 102(3), exchanging a card with user 102(3), or receiving a card from user 102(3). Moreover, the collaborative game move 512 may relate to shuffling the cards of the game 504 or performing another action that somehow benefits user 102(1) and/or user 102(3) with respect to the game 504, such as causing the users 102 on Team 1 to have a better likelihood of winning the game 504. Therefore, the users 102 may play the collaborative game moves 512 for the purpose of collaborating with users 102 that have a common goal with respect to the game 504 (e.g., Team 1 beating Team 2).

In further embodiments, a competitive game move 514 may correspond to any game move 128 that has a negative effect on other users 102 that are playing the game 504. As shown in FIG. 5, user 102(1) may make a competitive game move 514 with respect to user 102(4). Such competitive game moves 514 may entail adding cards to user 102(4)'s hand, replacing good cards with lesser cards, taking points or currency from user 102(4), etc. Therefore, a user 102 may make a competitive game move 514 in order to hinder the game performance of other users 102 that are playing the game 504 (e.g., causing those users 102 to have a lower likelihood of winning the game 504), which may include users 102 that are competing against the user 102.

Therefore, users 102 that are playing the game 504 may make various types of game moves 128 that have an effect on how users 102 are able to play the game 504. Users 102 may make individual game moves 510 that affect their own play of the game 504. In addition, users 102 may make collaborative game moves 512 in collaboration with other users 102 that are playing the game 504. As a result, users 102 that are aligned with one another (e.g., users 102 on the same team) may strategically play the collaborative game moves 512 to place themselves in a better position to win the game 504. Moreover, competitive game moves 514 may be made in an attempt to negatively affect other users 102 that are playing the game 504, thus allowing users 102 to make game moves 128 in a competitive manner. Accordingly, enabling users 102 to play multiple types of game moves 128 may introduce a real-time multi-player collaborative and/or competitive element to the game 504, which may result in a more positive and enjoyable gaming experience.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A system comprising:
memory;
one or more processors;
a game play module maintained in the memory and executable by the one or more processors to enable users to play a game;
a game management module maintained in the memory and executable by the one or more processors to:
determine one or more criteria associated with the game; and
determine that at least one of the users has caused the criteria to be satisfied; and
a game enhancement module maintained in the memory and executable by the one or more processors to modify a feature associated with the game based at least in part on the criteria being satisfied.

2. The system as recited in claim 1, wherein the game is played by the users in a physical setting or within a virtual environment accessible via a network.

3. The system as recited in claim 1, wherein the criteria corresponds to the at least one user playing a game move associated with the game.

4. The system as recited in claim 3, wherein the game move corresponds to an individual action associated with the game that is taken by the at least one user with respect to the at least one user.

5. The system as recited in claim 3, wherein the game move corresponds to a collaborative action associated with the game that is taken by the at least one user and that benefits at least a different one of the users.

6. The system as recited in claim 3, wherein the game move corresponds to a competitive action associated with the game that is taken by the at least one user and that negatively influences play of the game by a different one of the users.

7. The system as recited in claim 3, wherein modifying the feature associated with the game includes at least one of increasing a likelihood that the at least one user will win the game, increasing a likelihood that a different one of the users will win the game, or decreasing a likelihood that the different one of the users will win the game.

8. The system as recited in claim 1, wherein the criteria is satisfied by multiple of the users each performing a particular action with respect to the game in collaboration with one another.

9. The system as recited in claim 8, wherein the feature associated with the game is modified by enhancing or upgrading the feature with respect to the multiple users.

10. The system as recited in claim 8, wherein the feature associated with the game is unlocked and made available to the multiple users, where the features was previously not available to the multiple users.

11. A method comprising:
facilitating play of a game by multiple users;
associating one or more game moves with a particular one of the multiple users, each of the one or more game moves corresponding to actions performed by the user in collaboration with or in competition with at least some of the multiple users;
determining that the user has played at least one of the one or more game moves; and
causing an operation associated with the game to be performed based at least in part on the at least one game move.

12. The method as recited in claim 11, wherein the user plays the at least one game move with respect to the at least one user in collaboration with a different one of the multiple users.

13. The method as recited in claim 11, wherein the user plays the at least one game move with respect to a different one of the multiple users in collaboration with the different one of the multiple users.

14. The method as recited in claim 11, wherein the user plays the at least one game move with respect to a different one of the multiple users in competition with the different one of the multiple users.

15. The method as recited in claim 11, further comprising providing one or more additional game moves to the at least one user based at least in part on a performance, progress, or play of the at least one user with respect to the game.

16. One or more computer-readable media storing computer-executable instructions that, when executed by one or more processors, cause the one or more processors to perform operations comprising:
determining a criteria associated with a game being played by users;
determining that the criteria has been satisfied;
identifying multiple ones of the users that contributed to causing the criteria to be satisfied; and
presenting an enhancement associated with the game to at least a portion of the multiple users and based at least in part on the criteria being satisfied.

17. The one or more computer-readable media as recited in claim 16, wherein the enhancement includes enhancing or upgrading a feature associated with the game, and further comprising presenting the enhanced or upgraded feature to the at least a portion of the multiple users.

18. The one or more computer-readable media as recited in claim 16, wherein the enhancement includes unlocking a feature associated with the game to at least a portion of the multiple users, wherein the feature was previously not available to the at least a portion of the multiple users.

19. The one or more computer-readable media as recited in claim 16, wherein the enhancement is not presented to those users that did not participate in causing the criteria to be satisfied.

20. The one or more computer-readable media as recited in claim 16, wherein the enhancement includes an opportunity to acquire or receive the feature or one or more items associated with the game.
